(19) United States
(12) Patent Application Publication
(10) Pub. No.: US 2016/0241045 A1
(43) Pub. Date: Aug. 18, 2016

(54) PROTOCOLS FOR WIRELESS SOUND POWER TRANSMISSION

(71) Applicant: Energous Corporation, San Jose, CA (US)

(72) Inventor: Michael A. Leabman, San Jose, CA (US)

(21) Appl. No.: 14/622,451

(22) Filed: Feb. 13, 2015

(51) Int. Cl. H02J 5/00; H02J 7/02

(52) U.S. Cl. CPC H02J 5/005; H02J 7/025

(57) ABSTRACT

The present disclosure provides control protocols for wireless sound power transmission. An embodiment is presented where wireless sound power transmission may be carried out through pocket-forming where at least one transmitter, which may further include at least one micro-controller for digital signal processing, and one receiver may be utilized. In addition, control protocols which can be used by a micro-controller for authenticating electronic devices requiring wireless power may be provided. Further, control protocols for delivering wireless power to electronic devices may be provided. Lastly, micro-controller may store powering statistics in a processor which may be useful for users and the like.

### CROSS-REFERENCES TO RELATED APPLICATIONS

The present disclosure is related to U.S. Non-Provisional patent application Ser. No. 13/891,399 filed on May 10, 2013, entitled “Receivers For Wireless Power Transmission”; Ser. No. 13/891,430 filed on May 10, 2013, entitled “Methodology for Pocket-forming” and Ser. No. 13/891,445 filed on May 10, 2013, entitled “Transmitters For Wireless Power Transmission”; invented by Michael A. Leabman, the entire contents of which are incorporated herein by these references.

### FIELD OF INVENTION

The present disclosure relates to control protocols, and more particularly to control protocols for wireless sound power transmission.

### BACKGROUND OF THE INVENTION

The situation where electronic devices run out of power, because users fail to charge them, is an ever-present problem. The foregoing problem may be exacerbated by the burden imposed on users on carrying chargers, for powering their devices, which may need to be plugged into a wall outlet for example. This may result in devices being constrained to a given space, which may turn their operation unpleasant. In addition, if a wall outlet is not available, the device may run out of power and become virtually unusable. The foregoing problem has partially been solved by providing devices with replaceable batteries. However, such a solution creates the new problem of having to carry such batteries anywhere a user goes. Thus, wireless sound power transmission techniques such as resonating coils, sound wave (SW) harvesting or pocket-forming, to name a few, may be suitable solutions for the foregoing problems. However, given the flexibility of wireless sound power transmission, i.e. not requiring cables, extra batteries and the like, there may be a need for protocols for controlling such power transmission.

### SUMMARY OF THE INVENTION

The present disclosure provides control protocols for wireless sound power transmission carried out through suitable techniques such as pocket-forming, resonating coils and the like.

In an embodiment, a pocket-forming methodology, where at least one transmitter and one receiver are utilized for wireless sound power transmission, may be provided.

In another embodiment, a routine which may be carried out by a micro-controller in a transmitter or the like for authenticating an electronic device including at least one receiver may be provided.

In a further embodiment, a routine which may be carried out by a micro-controller in a transmitter or the like for delivering power wirelessly to an electronic device including at least one receiver may be provided.

The protocols here disclosed can be used to control wireless sound power transmission in places like home, workplace or stores providing wireless sound power. Such protocols may be aimed at controlling which devices can be wirelessly sound power and the suitable conditions for wireless sound power transmission. In addition, a micro-controller may store power statistics in a processor which may then be retrieved by a user or the like.

The method of control protocols for a wireless sound power transmission system, comprising: generating two or more sound waves from a transmitter having a micro-controller for digital signal processing in response to receiving a signature signal from a receiver requesting a power delivery; forming controlled constructive and destructive interference patterns from the generated sound waves controlled by the micro-controller; accumulating energy or power in the form of constructive interference patterns from the sound waves to form pockets of energy; converging the pockets of energy in 3-d space to a targeted electronic device connected to the receiver sending the signature signal; evaluating the signature signal sent by the receiver to authenticate the identification of the targeted electronic device for reception of the pockets of energy to charge the electronic device; and determining the power delivery profile of the targeted and authenticated electronic device to meet the request for power delivery by the receiver for charging or operating the electronic device.

### BRIEF DESCRIPTION OF THE DRAWINGS

Embodiments of the present disclosure are described by way of example with reference to the accompanying figures, which are schematic and may not be drawn to scale. Unless indicated as representing prior art, the figures represent aspects of the present disclosure.

FIG. 1 shows a transmitter that can be used for pocket-forming, according to an embodiment.

FIG. 2 shows a receiver that can be used for pocket-forming, according to an embodiment.

FIG. 3 is an illustration of the methodology used for pocket-forming where at least one transmitter (as described in FIG. 1 above) and one receiver (as described in FIG. 2 above) may be included, according to an embodiment.

FIG. 4 illustrates an example routine that may be utilized by a micro-controller from transmitter (as described in FIG. 1) to authenticate devices requiring wireless power transmission, according to an embodiment.

FIG. 5 illustrates an example routine that may be utilized by a micro-controller from transmitter (as described in FIG. 1) to deliver power to devices previously authenticated in the routine described in FIG. 4 above, according to an embodiment.

### DETAILED DESCRIPTION OF THE DRAWINGS

“Pocket-forming” may refer to generating two or more sound waves which converge in 3-d space, forming controlled constructive and destructive interference patterns.

“Pockets of energy” may refer to areas or regions of space where energy or power may accumulate in the form of constructive interference patterns of sound waves.

“Null-space” may refer to areas or regions of space where pockets of energy do not form because of destructive interference patterns of sound waves.

“Transmitter” may refer to a device, including a chip which may generate two or more SOUND signals, at least one SOUND signal being phase shifted and gain adjusted with respect to other SOUND signals, substantially all of which pass through one or more SOUND antenna or piezo-electric device such that focused SOUND signals are directed to a target.

“Receiver” may refer to a device which may include at least one sound antenna or sensor, at least one rectifying circuit and at least one power converter for powering or charging an electronic device using SOUND waves.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting. Other embodiments may be used and/or other changes may be made without departing from the spirit or scope of the present disclosure.

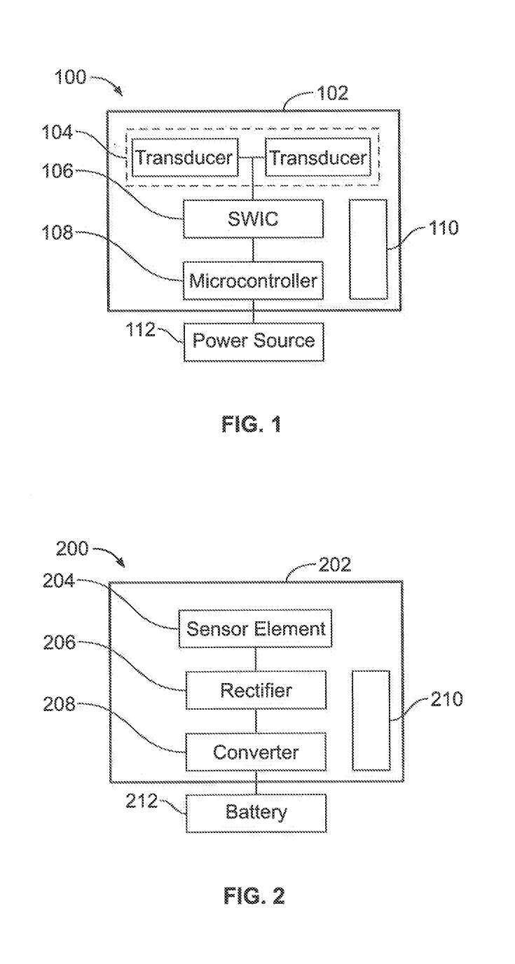

FIG. 1 shows an example of a transmitter 100 that can be used for pocket-forming. In this embodiment, transmitter 100 may be used to provide wireless power transmission. Transmitter 100 may include a housing 102 having at least two or more transducer sound elements 104, at least one sound wave integrated circuit (SWIC 106), at least one digital signal processor (DSP) or micro-controller 108, and one communications component 110 and an external power source 112. Housing 102 can be made of any suitable material which may allow for signal or wave transmission and/or reception, for example plastic or hard rubber. Sound elements 104 may include suitable antenna types for operating in frequency bands of 60 KHz or less. Transducer sound elements 104 may include piezo-electric speaker devices as well as other suitable combinations of piezo-electric devices. Micro-controller 108 may then process information sent by a receiver through communications component 110 for determining optimum times and locations for pocket-forming. Communications component 110 may be based on standard wireless communication protocols which may include Bluetooth, Wi-Fi or ZigBee. In addition, communications component 110 may be used to transfer other information such as an identifier for the device or user, battery level, location or other such information. Other communications component 110 may be possible which may include radar, infrared cameras or sound devices for sonic triangulation for determining the device's position.

FIG. 2 shows an example of a receiver 200 that can be used for pocket-forming. In this embodiment, receiver 200 may be used for powering or charging an electronic device. Receiver 200 may also include a housing 202 having at least one sensor element 204, one rectifier 206, one power converter 208 and one or more communications component 210. Housing 202 can be made of any suitable material which may allow for signal or wave transmission and/or reception, for example plastic or hard rubber. Housing 202 may be an external hardware that may be added to different electronic equipment, for example in the form of cases, or can be embedded within electronic equipment as well. Sound sensor elements 204 may include suitable piezo-electric types for operating in frequency bands such as those described for transmitter 100 from FIG. 1. Sensor element 204 may include combinations of various piezo-electric sensors. Using multiple sensors can be beneficial in devices where there may not be a preferred orientation during usage or whose orientation may vary continuously through time, for example a smartphone or portable gaming system. On the contrary, for devices with well-defined orientations, for example a two-handed video game controller, there might be a preferred sensors which may dictate a ratio for the number of sensors of a given type.

Suitable sensor types may include piezo-electric devices of various sizes. Sound sensors may have the advantage over other types of energy transmission via RF signals for example. This may further prove advantageous as a receiver, such as receiver 200, may dynamically modify its sensors to optimize wireless power transmission. Rectifier 206 may include diodes or resistors, inductors or capacitors to rectify the alternating current (AC) voltage generated by sensor element 204 to direct current (DC) voltage. Rectifier 206 may be placed as close as is technically possible to sensor element 204 to minimize losses. After rectifying AC voltage, DC voltage may be regulated using power converter 208. Power converter 208 can be a DC-DC converter which may help provide a constant voltage output, regardless of input, to an electronic device, or as in this embodiment to a battery 212. Typical voltage outputs can be from about 5 volts to about 10 volts. Lastly, a communications component 210 may be included in receiver 200 to communicate with a transmitter or to other electronic equipment. Such a communications component 210 may be based on standard wireless communication protocols which may include Bluetooth, WI-Fi or ZigBee similar to communications component 110 from transmitter 100.

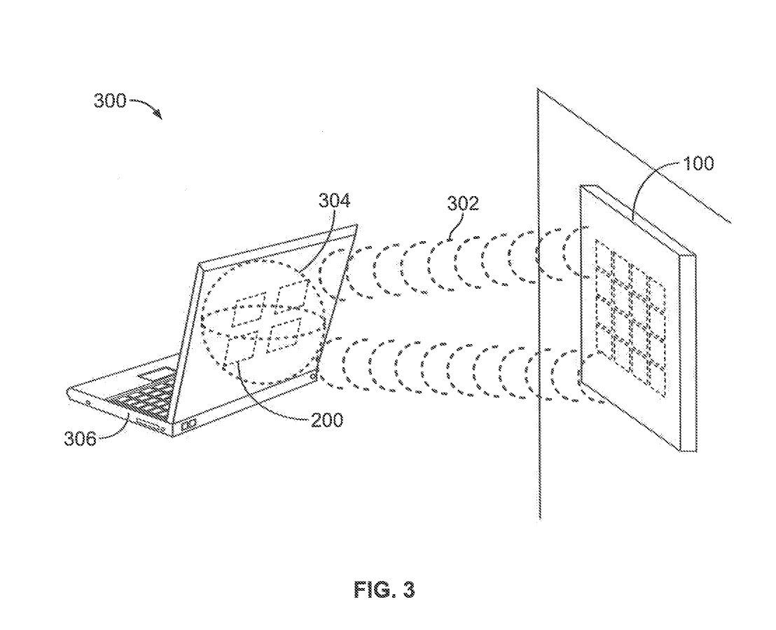

FIG. 3 is an exemplary illustration of the methodology used for pocket-forming 300, which may include one transmitter 100 and at least one or more receivers 200. Receiver 200 may communicate with transmitter 100 by generating a short signal (e.g., RF) through sensor elements 204 or an internal antenna in order to locate its position with respect to the transmitter 100. In some embodiments, receiver 200 may additionally utilize at least one communications component 210 to communicate with other devices or components. Communications components 210 may enable receiver 200 to communicate using a wireless protocol. As described in FIG. 1 and FIG. 2, the wireless protocol can be a proprietary protocol or use a conventional wireless protocol such as Bluetooth, Wi-Fi, ZigBee, etc. Communications component 210 may then be used to transfer information such as an identifier for the device as well as battery level information, geographic location data, or other information that may be of use for transmitter 100 in determining when to send power to receiver 200, as well as the location to deliver power. In other embodiments, adaptive pocket-forming may be used to regulate power on electronic devices.

Once transmitter 100 identifies and locates receiver 200, a channel or path can be established by knowing the gain and phases coming from receiver 200. Transmitter 100 may start to transmit controlled sound wave frequency (SW) waves 302 which may converge in 3-d space by using a minimum of two antenna elements 104. These sound waves 302 may be produced by transmitter 100 using an external power source 112 and a local oscillator chip using a suitable piezoelectric material. Sound waves 302 may be controlled by SWIC 106 which may include a proprietary chip for adjusting phase and/or relative magnitudes of sound wave signals which may serve as inputs for transducer elements 104 to form constructive and destructive interference patterns (pocket-forming). Pocket-forming 300 may take advantage of interference to change the directionality of the sound transducer elements 104 where constructive interference generates a pocket of energy 304 and deconstructive interference generates null space. Receiver 200 may then utilize pocket of energy 304 produced by pocket-forming for charging or powering an electronic device, for example a laptop computer 306 and therefore effectively providing wireless power transmission.

As described above, wireless power transmission can be very flexible through pocket-forming. No extra cables, wires or batteries may be required. In addition, power transmission can be done through space, and at any time a user requires it. This may eliminate many of the burdens typically associated with charging or powering electronic devices. However, protocols may be useful for controlling such a power transmission. In addition, the following protocols can also be used for other suitable wireless power transmission techniques such as resonating coils, RF harvesting and even magnetic induction.

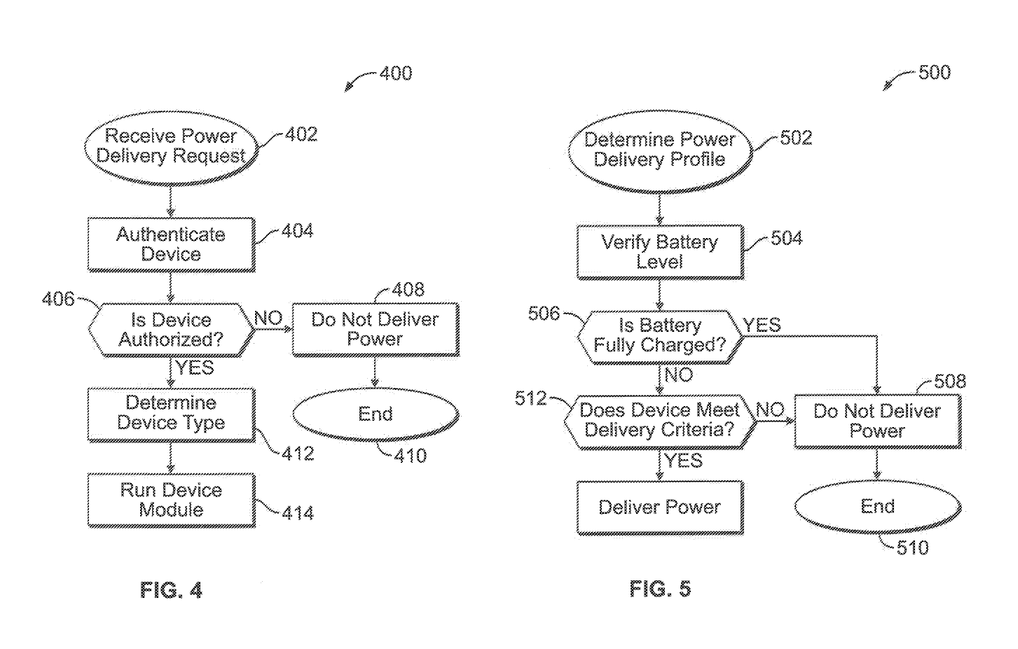

FIG. 4 illustrates an example routine 400 that may be utilized by micro-controller 108 from transmitter 100 to control wireless power transmission. Routine 400 may begin when transmitter 100 receives a power delivery request 402 from receiver 200. At Power delivery request 402, receiver 200 may send a signature signal which may be coded using suitable techniques such as delay encoding, orthogonal frequency-division multiplexing (OFDM), code division multiplexing (CDM) or other suitable binary coding for identifying a given electronic device including receiver 200. At this stage, micro-controller 108 may proceed to authenticate 404 where it may evaluate the signature signal sent by receiver 200. Based on authenticate 404, micro-controller 108 may proceed to a decision 406. If receiver 200 is not authorized to receiver power, micro-controller 108 may decide, at decision 406, to don't deliver power 408, and thus end routine 400 at end 410. On the other hand, if receiver 200 is authorized to receive power, micro-controller 108 may proceed to determine device type 412. At this step, micro-controller 108 may obtain information from receiver 200 such as type of device, manufacturer, serial number, total power required, battery level among other such information. Afterwards, micro-controller 108 may proceed to run device module 414, where it may run a routine suited to the authenticated device. In addition, if multiple receivers 200 are requiring power, micro-controller 108 may deliver power equally to all receivers 200 or may utilize a priority status for each receiver 200. Such a priority status may be user defined. In some embodiments, the user may choose to deliver more power to its smartphone, than to its gaming device. In other cases, the user may decide to first power its smartphone and then its gaming device.

FIG. 5 illustrates an example of a routine 500 that may be utilized by micro-controller 108 at device module 414. Routine 500 may start at determine power delivery profile 502 where it may decide to either run on a default power profile or a user custom profile. In the case of the former, micro-controller 108 may proceed to verify battery level 504 where it may determine power needs of the electronic device including receiver 200. Afterwards, micro-controller 108 may proceed to a decision 506. If the battery of the electronic device including receiver 200 is fully charged, at decision 506, micro-controller 108 may proceed to don't deliver power 508, and thus end routine 500 at end 510. On the other hand, if the battery of the electronic device including receiver 200 is not fully charged, micro-controller 108 may proceed to verify if such electronic device meet specific powering criteria at decision 512. The foregoing powering criteria may depend on the electronic device requiring power. For example, smartphones may only receive power if are not being used, or may be during usage but only if the user is not talking through it, or may be during usage as long as WI-Fi is not compromised among other such criteria. In the case of a user custom profile, the user may specify the minimum battery level its equipment can have before delivering power, or the user may specify the criteria for powering his or her device among other such options.

Alternatively, micro-controller 108 may also record data on a processor on transmitter 100. Such data may include powering statistics related to how often does a device require power, at what times is the device requesting power, how long it takes to power the device, how much power was delivered to such device, the priority status of devices, where is the device mostly being powered (for example at home or in the workplace). In addition, such statistics could be uploaded to a cloud based server so that the user can look at all such statistics. In some embodiments, stores, coffee shops and the like providing wireless power as a secondary service may use the aforementioned statistics for charging a user the corresponding monetary amounts for the total power received. In some cases, users may buy powering time, for example, a user may pay for an hour of power. Thus, the aforementioned statistics can help micro-controller 108 decide when to stop delivering power to such a user.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

Having thus described the invention, I claim:

1. A method of control protocols for a wireless sound power transmission system, comprising:
generating two or more sound waves from a transmitter having a micro-controller for digital signal processing in response to receiving a signature signal from a receiver requesting a power delivery;
forming controlled constructive patterns from the generated sound waves controlled by the micro-controller;
accumulating energy or power in the form of constructive interference patterns from the sound waves to form pockets of energy;
converging the pockets of energy in 3-d space to a targeted electronic device connected to the receiver sending the signature signal;
evaluating the signature signal sent by the receiver to authenticate the identification of the targeted electronic device for reception of the pockets of energy to charge the electronic device; and
determining the power delivery profile of the targeted and authenticated electronic device to meet the request for power delivery by the receiver for charging or operating the electronic device.

2. The method of control protocols for a wireless sound power transmission system of claim 1, further including the method of forming controlled destructive patterns from the sound waves controlled by the micro-controller and accumulating energy or power in the form of destructive interference patterns from the sound waves to form null-space without pockets of energy wherein the signature signal further includes the method of delay encoding, orthogonal frequency-division multiplexing, code division multiplexing or other suitable binary coding for identifying the electronic device by the micro-controller.

3. The method of control protocols for a wireless sound power transmission system of claim 1, further comprising communicating circuitry in the transmitter and receiver for sending coded signature signals for authentication and power profile of the targeted electronic device.

4. The method of control protocols for a wireless sound power transmission system of claim 1, wherein the communicating circuitry uses Bluetooth, infrared, Wi-Fi or FM radio signals for communication between the transmitter and the receiver.

5. The method of control protocols for a wireless power transmission system of claim 1, further comprising micro-controller computing instructions for processing the signature signals from the requesting receiver representing the type of electronic device, manufacturer, serial number, total power required, battery level and other power profile requirements of each specific electronic device to adjust the received pockets of energy for each electronic device.

6. A control protocol for a wireless sound power transmission system, comprising:
a transmitter for generating pockets of energy to a receiver electrically connected to at least one electronic device; and
a micro-controller for receiving coded signature signals from the receiver and connected to a communication network between the transmitter and receiver for controlling an authentication and a power profile of each electronic device receiving the pockets of energy.

7. The control protocol for a wireless sound power transmission system of claim 6, wherein the transmitter generates two or more sound waves from at least two sound transmit transducer to create constructive interference patterns from the sound waves to form the pockets of energy.

8. The control protocol for a wireless sound power transmission system of claim 6, wherein the receiver generates the coded signature signals requesting power delivery from the transmitter to the receiver of the electronic device.

9. The control protocol for a wireless sound power transmission system of claim 6, wherein the generated pockets of energy are received by a plurality of authenticated electronic devices according to the power profile of each electronic device.

10. The control protocol for a wireless sound power transmission system of claim 6, wherein the micro-controller includes predetermined protocols for determining the proper authentication of the electronic device to receive the pockets of energy for charging or operating the electronic device.

11. A system for wireless sound power transmission, comprising:
a transmitter for generating two or more sound waves to form controlled constructive interference patterns from the generated sound waves;
a micro-controller within the transmitter controlling a predetermined configuration of the constructive interference patterns of sound waves to form pockets of energy for a receiver connected to at least one electronic device for accumulating the pockets of energy converging in 3-d space to charge the electronic device; and
communication protocols connected between the transmitter and receiver for processing a coded signature signal by the micro-controller to authenticate and to determine power level requirements of the electronic device.

12. The system for wireless sound power transmission of claim 11, further including the transmitter generating two or more sound waves to form controlled destructive interference patterns of sound waves to form null-spaces without pockets of energy and wherein the micro-controller includes instructions for processing the coded signature signals to determine the authentication and power requirements of the electronic device.

13. The system for wireless power transmission of claim 11, wherein the communication network includes Bluetooth, infrared, Wi-Fi or FM radio signals.

14. The system for wireless power transmission of claim 11, wherein the coded signature signals include delay encoding, orthogonal frequency-division multiplexing, code division multiplexing or other suitable binary coding for identifying the electronic device by the micro-controller.

15. The system for wireless power transmission of claim 11, wherein the receiver provides the signature signals with information concerning the type of electronic device, the manufacturer of the device, the serial number of the device, power requirements of the device and battery level of the device for processing by the micro-controller.

16. The system for wireless power transmission of claim 11, wherein the electronic device is a cellphone, iPad, iPod, Tablet, iPhone, an Android device or other electronic device for charging a battery associated with the device or for operating the device.

17. The system for transmitting wireless power of claim 11, wherein the transmitter produces pocket-forming over a plurality of electronic devices.

18. The system for transmitting wireless power of claim 11, wherein the processor is a computer, an ASIC, a controller, microprocessor or other similar device that is capable of processing instructions.

19. The system for transmitting wireless power of claim 11, wherein the micro-controller stores power data, times requesting power, length of time for charging, amount of power delivered, priority status or other useful statistics for each charged or operated electronic device which electronic device data is capable of being wirelessly uploading to a base station or Internet location for future reference or manipulation.

20. The system for wireless power transmission of claim 11, wherein the micro-controller dynamically adjusts the pocket-forming to regulate the delivery of power to one or more targeted electronic devices to monetize the amount of power received by a customer of the system.
